(19) United States
(12) Patent Application Publication
(10) Pub. No.: US 2005/0227510 A1
(43) Pub. Date: Oct. 13, 2005

(54) Small array contact with precision working range

(76) Inventors: Dirk D. Brown, Mountain View, CA (US); John D. Williams, Campbell, CA (US)

Correspondence Address: PILLSBURY WINTHROP SHAW PITTMAN LLP, 1650 TYSONS BOULEVARD, MCLEAN, VA, 22102, US

(21) Appl. No.: 10/960,043

(22) Filed: Oct. 8, 2004

(30) Foreign Application Priority Data
Apr. 9, 2004 (WO) PCT/US04/11074

(51) Int. Cl. H01R 12/00

(52) U.S. Cl. 439/66

(57) ABSTRACT

A contact of a connector element arranged in an array of connector elements having desirable mechanical and electrical properties simultaneously, as defined by a robust working range. An array pitch is preferably within a range of about 0.05 mm to about 1.27 mm, and preferably within a range of about 0.05 mm to 1 mm. The contact includes a base portion and an elastically deformable portion that protrudes from a plane containing the base and is configured to provide a working range of about 0.0 mm to about 1.0 mm.

This application claims the benefit, under 35 U.S.C. § 120, of the following copending and commonly assigned patent applications: U.S. patent application Ser. No. 10/731,669, entitled “A Connector for Making contact at Semiconductor Scales,” of Dirk D. Brown, et al., filed on Dec. 8, 2003; PCT Application No. US2004/011074, entitled “Electrical Connector and Method for Making,” of Dirk D. Brown, et al., filed on Apr. 9, 2004.

### BACKGROUND

1. Field of the Invention

The present invention relates generally to electrical connectors, and more specifically, to elastic electrical connectors used to join electronic components.

2. Background of the Invention

Conventional electrical connectors used to connect components such as printed circuit boards are fabricated using a wide variety of techniques. A common approach is to use stamped metal springs, which are formed and then individually inserted into an insulating carrier to form an array of electrical connection elements. Other approaches to making electrical connectors include using anisotropically conductive adhesives, injection molded conductive adhesives, bundled wire conductive elements, and small solid pieces of metal.

As the desire for device performance enhancement drives packaging technology to shrink the spacing (or the pitch) between electrical connections (also referred to as a “leads”), a need exists to shrink the size of individual connector elements. At the same time, the total number of connections per package is increasing. For example, existing integrated circuit (IC) packages may be built with a pitch of 1 mm or less with 600 or more connections. Furthermore, IC devices are designed to be operated at increasingly higher frequencies. For example, IC devices for use in computing, telecommunication, and networking applications can be operated at a frequency of several GHz. Operating frequencies of the electronic devices, package size, and lead count of the device packages thus place stringent requirements on the interconnect systems used to test or connect these electronic devices.

In particular, the mechanical, electrical, and reliability performance criteria of an interconnect system are becoming increasingly demanding. Electrical and mechanical reliability specifications for use with high speed, small dimension and large pin count IC devices can place requirements that conventional interconnect technologies described above cannot easily fulfill. In general, conventional connector systems optimized for electrical performance have poor mechanical and reliability properties, while connector systems optimized for mechanical performance and improved reliability have poor electrical characteristics.

A particular problem encountered by today's interconnect systems is non-coplanarity of leads in the electronic components to be connected. Coplanarity of elements in a planar package exists, for example, when those elements reside within a common reference geometrical plane. In a conventional package, factors that can contribute to non-coplanarity of connector elements (or leads) of the package include manufacturing variability and substrate warpage. For conventional connector elements arranged in an array, coplanarity variation across a package may exceed vertical tolerances for connector elements, resulting in failure of electrical connection in some elements.

Coplanarity problems are not limited to IC packages but may also exist in a printed circuit board (PC board) to which these IC packages are attached. Coplanarity problems may exist for land grid array pads formed as an area array on a PC board due to warpage of the PC board substrate. Typically, deviation from flatness in a conventional PC board is on the order of 75 to 125 microns or more per inch.

Additionally, the deviations from planarity in circuit boards, packages, and other components in which arrays of electrical connectors are employed, often may not scale down as other dimensions, such as array spacing and connector size decrease. Thus, for example, large vertical deviations in positions of contacts may occur even for circuit boards or other components that have smaller pitch. For conventional connectors having pitch of less than about 2 mm between connector contacts, it becomes more difficult as the pitch decreases to produce elastic contacts that can compensate for such coplanarity deviations and still realize acceptable electrical contact properties, such as low resistance and low inductance.

### BRIEF DESCRIPTION OF THE DRAWINGS

FIG. 1 is a property graph for a contact of a connector element of the present invention.

FIG. 2 is a schematic diagram that illustrates a plan view of an exemplary fully formed single sided rolling beam contact 200.

FIG. 2b is a schematic diagram that depicts a cross-section of the contact of FIG. 2 along line A-A′.

FIG. 3 is a schematic diagram that illustrates the single sided rolling beam contact of FIG. 2, at an intermediate stage of processing.

FIG. 3b is a schematic diagram that illustrates a perspective view of the contact of FIG. 3.

FIG. 4 is a plot of resistance and load versus displacement for an exemplary single sided rolling beam contact.

FIG. 5 is a load-displacement plot applied to an exemplary extended rolling beam contact.

FIG. 6 is a schematic diagram of a plan view of an exemplary dual sided double flange contact.

FIG. 6b is a plot of dB loss as a function of frequency for a contact configured for a 1.27 mm array pitch and having the contact structure according to FIG. 6.

FIG. 6c is a plot of load and resistance versus displacement for a double sided flanged contact having a contact structure according to FIG. 6.

FIG. 7 is a plot of load and resistance versus displacement for a contact having the shape of the contact structure of FIG. 2, arranged in an array of 0.5 mm pitch.

FIG. 8 is a plot of load-displacement data for a “half-hard” contact arranged in an array of 127 mm pitch and having the structure disclosed in FIGS. 2 and 2b.

FIG. 9 is a schematic diagram that illustrates an exemplary three flange contact designed to contact a solder ball.

FIG. 9b is a load-displacement plot illustrating three load-unload cycles of the contact of FIG. 9.

FIG. 10 illustrates exemplary steps involved in a process for forming array contacts, according to a configuration of the present invention.

FIGS. 11a-11h illustrate exemplary steps involved in another process for forming array contacts according to another configuration of the present invention.

### DETAILED DESCRIPTION

A feature of the present invention is the working range of one or more contacts of a connector element arranged in an array of connector elements in which the array spacing (also termed “pitch”, and referring to the distance separating the centers of nearest neighbor connectors) is within a range of about 0.05 mm to about 5 mm, and preferably within a range of about 0.05 mm to 2 mm. The term “connector element” as used herein refers to any entity that can form an electrically conductive path between conductive elements. Each connector element includes a contact that can further include a plurality of contact portions at least one of which is substantially elastically deformable over a range of displacement. As used herein, the term “working range” denotes a range over which a property or group of properties conform to predetermined criteria. The working range is a range of distance (displacement) through which the deformable contact portion(s) can be mechanically displaced while meeting predetermined performance criteria including, without limitation, physical characteristics such as elasticity and spatial memory, and electrical characteristics such as resistance, impedance, inductance, capacitance and/or elastic behavior.

In one configuration, the contact is located in a connector element of a coplanar array of connector elements that comprises a planar connector. Preferably, each contact has a base portion comprising conductive material, in addition to an elastically deformable portion comprising conductive material that extends from the base portion and protrudes above the surface of the plane containing the array of connector elements.

By fabricating a contact in which the deformable elastic portion is formed integrally with the base portion, using film coating, lithographic patterning, etching and forming technologies, many configurations of the present invention can form small contacts in arrays having pitches within a range of about 0.05 mm to about 5 mm, and as demonstrated herein, within a range of about 0.5 mm to 1.27 mm, while providing a working range unattainable by conventional technologies. In one configuration of the present invention, a lateral dimension of the contact is within a range of about 0.5 mm to about 100 nm. In another configuration, shown herein, the deformable contact portion exhibits a suitable working range within a range of about 0.0 mm to about 1.0 mm. In another configuration, the deformable contact portion exhibits a normalized working range within a range of about 0.20 to about 0.44 for a single sided contact and about 0.40 to about 0.88 for a double sided contact. A double sided contact has contacts on opposed surfaces of a substrate. Double sided connectors may be fabricated using the techniques described herein and may be formed into a circuit. As used herein, the term “normalized working range” is a dimensionless quantity that represents the working range of a contact divided by the array pitch of the connector array in which the contact is located.

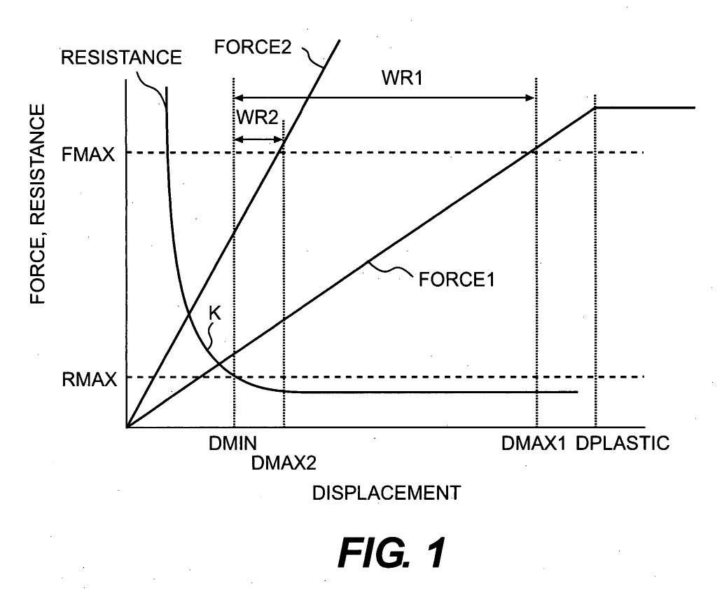

FIG. 1 is a property graph for a contact in a connector element of the present invention. The graph plots electrical resistance and external force applied versus contact displacement for an electrical connector element. For a given application, a connector element may be required to meet a specified resistance value, which typically is characterized by an upper limit of tolerable resistance. In addition, for most applications of elastic connector elements, an applied displacement should not exceed a value above which the elastic contact portion does not behave in an elastic manner. Accordingly, in the example of FIG. 1, a working range can be defined as an absolute value of a range of applied displacement over which the connector element has a resistance below the tolerable resistance limit and over which the elastic portion maintains an elastic response to applied displacement or force.

In FIG. 1, the tolerable resistance limit is represented by Rmax. As plotted, the measured electrical resistance decreases with increasing displacement of the contact, and at Dmin, the resistance attains the value of Rmax. At higher displacement values, the measured electrical resistance remains below the Rmax value. Thus, a lower limit of working range can be set at the displacement value Dmin above which the connector resistance is less than Rmax.

The force curve Forcel exhibits reproducible behavior with contact displacement over a range up to the value denoted as Dplastic. In this linear range, displacement or force can be applied to a contact with complete elastic recovery of the deformable contact portion when the external displacement is removed. As illustrated, at displacement values above Dplastic, increases in contact displacement occur with little or no increase in applied force, which indicates the onset of plastic deformation. Accordingly, a contact subject to deformation beyond Dplastic will exhibit permanent deformation that does not recover when the load is removed, thus reducing the elastic range of the contact portion.

Accordingly, in the example shown, the upper limit of working range WR1 is set at a displacement value below the point Dplastic, to ensure that the external displacement does not cause irrecoverable displacement in the elastic contact portion. For example, this limit might be set at a displacement value at some margin below the Dplastic value to ensure reliable contact performance. Alternatively, as illustrated in FIG. 1, an upper limit on working range Dmax1 may be set by a maximum clamping force available to be applied to a contact. For example, for an array of connectors containing elastic contacts used to electrically connect a land grid array and a printed circuit board, a maximum total clamping force may be specified. The total maximum clamping force then corresponds to a maximum clamping force, Fmax, available per elastic contact of the connector array.

In conventional stamped spring technology (curve Force2) used for connector arrays, spring stiffness is exceedingly large for pitches less than about 2 mm. Accordingly, large applied forces are required to induce small displacements, with the result that the required applied force reaches Fmax at a lower displacement value. Accordingly, for conventional stamped springs, an upper limit Dmax2 of working range is reached at a low displacement value. Assuming a similar Dmin for a conventional stamped spring, the working range WR2 is greatly reduced with respect to WR1, as indicated.

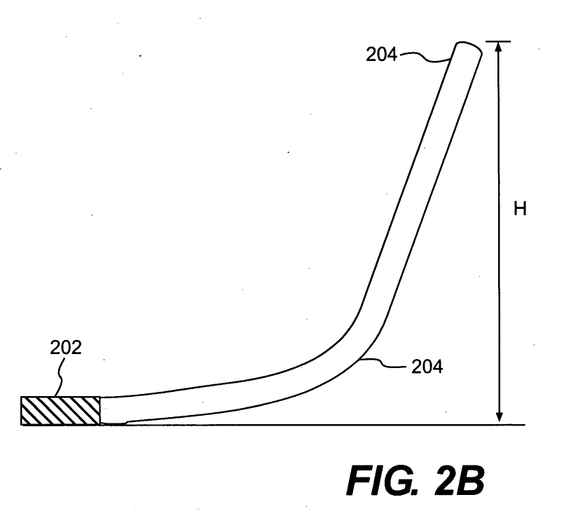

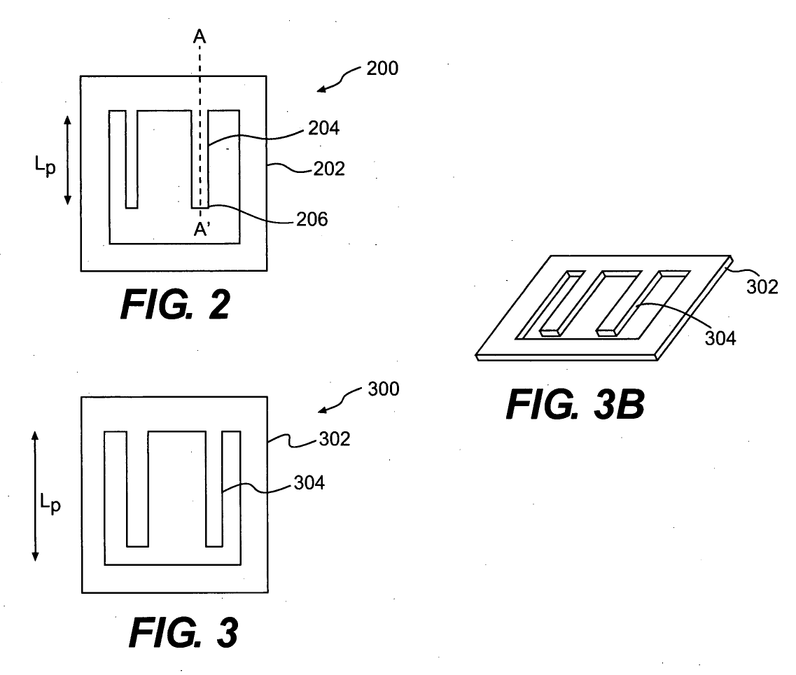

FIG. 2 illustrates a plan view of an exemplary fully formed single sided rolling beam contact 200, according to a configuration of the present invention. In this configuration, rolling beam contact 200 of FIG. 2 is formed as part of a connector element (not shown) of a coplanar array of connector elements. The plan view illustrated in FIG. 2 is from a perspective normal to a plane containing coplanar contact elements. Contact 200 includes base portion 202 that comprises a metallic material and is configured to lie in a plane, and has dimensions along mutually orthogonal “X” and “Y” axes of about 0.4 mm and 0.5 mm, respectively. Elastically deformable portions (also generally referred to hereinafter as “elastic portions” or “spring portions”) 204 are formed integrally continuous with base portion 202 and comprise the same metallic material. In this configuration, elastic portions 204 comprise single sided metallic rolling beams each of whose actual dimension along a longest direction of the beam is about 1.5 mm.

As illustrated in FIG. 2b, depicting a cross-section along line A-A′ of FIG. 2, rolling beams 204 form an upward curving shape and extend above a plane containing base portion 202 such that, with respect to a line perpendicular to a plane containing base portion 202, a distal end 206 of rolling beams 204 lies at a height H, about 0.6 mm above the plane. From the perspective of FIG. 2, a projected beam length Lp of free standing rolling beams 204 in the direction of line A-A′ is about 1.16 mm.

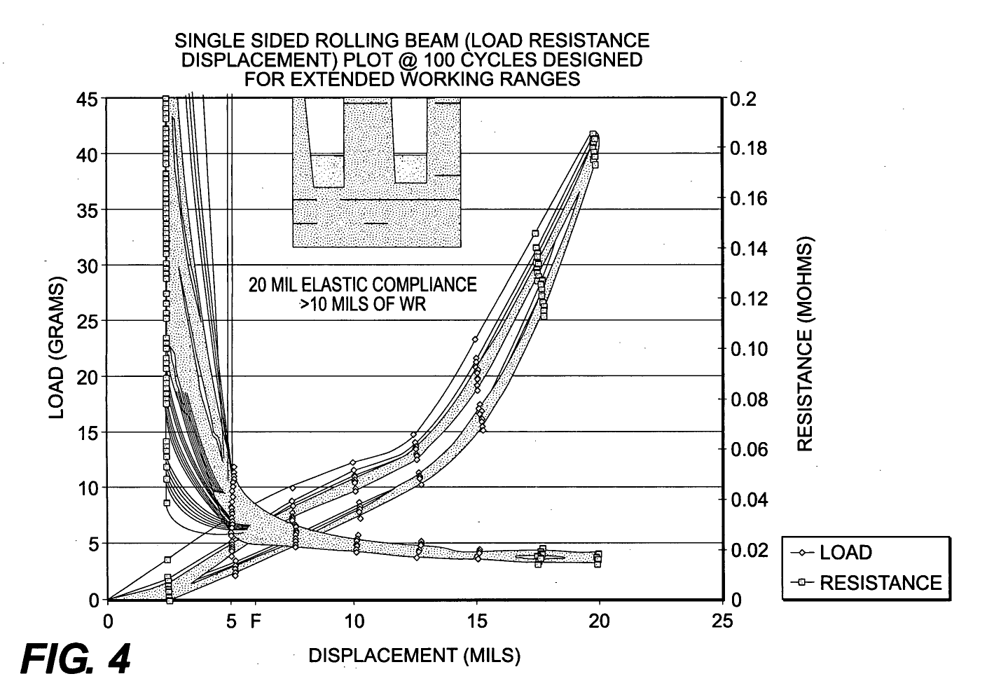

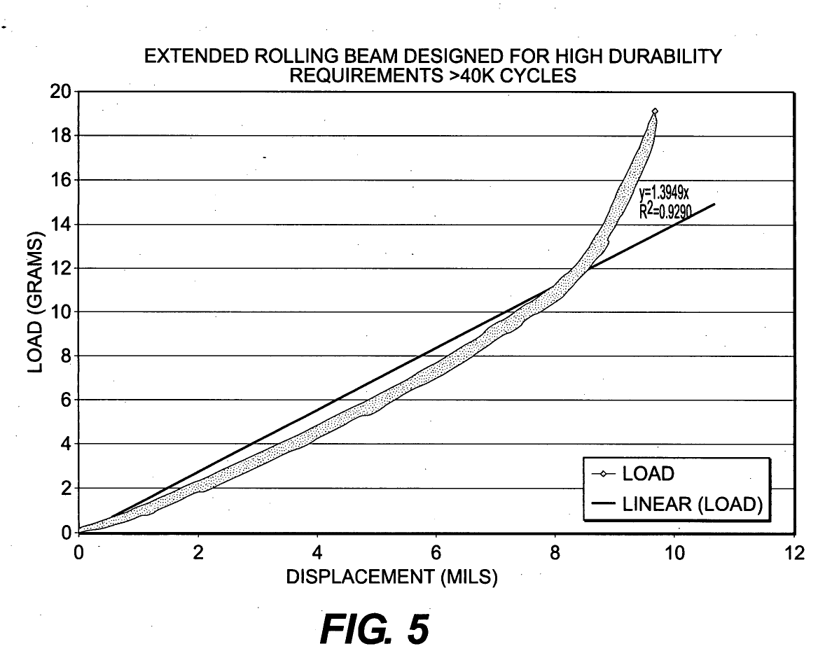

FIG. 3 illustrates a plan view of a partially formed single sided rolling beam contact 300 corresponding to fully formed contact 200 (FIG. 2) at an intermediate stage of processing. As illustrated in FIG. 3b, base portion 302 and beam portions 304 are coplanar. FIG. 3 shows that a projected beam length Lp is 1.5 mm, equivalent to the actual beam length along its long axis. Referring again to FIG. 2, in a configuration of the present invention, the shape of beams 204, height H, and Lp are determined by a “forming” process in which initially planar beams 304 of FIG. 3 are deformed over a three dimensional body embedded in a planar surface. The deformation process serves to impart a shape illustrated in FIGS. 2 and 2b. Thus, a 1.5 mm rolling beam having a 0.63 mm height can be formed in a contact of outer (base) dimensions of about 2.1×2.1 mm. Because contact 200 is formed using known lithographic and etch techniques that are effective in defining sub-micron sized features, a pitch in an array containing contact 200 can easily be set at a dimension only nominally larger than the contact size. This is because the sub-micron tolerances of lithography and etching techniques used to form contact 200 are much smaller than the actual contact size.

Exemplary Experimental Results

The following subheadings set forth results of measurements performed using contacts of the present invention. Experimental data was measured and collected by a simple load-displacement-resistance apparatus designed to detect load in grams, displacement in mils, and resistance in ohms.

In the examples to follow, an upper limit on working range, corresponds to a displacement corresponding to the onset of plastic deformation, a displacement limit of a contact, or a load value greater than 50 g.

Additionally, for examples in which a resistance of a contact is measured, a lower limit of working range is defined at a displacement value above which electrical resistance versus displacement traces a substantially unvarying curve in each measurement cycle, and above which value the electrical resistance varies much less rapidly than at low displacement values. Thus, in the examples to follow, rather than being defined by an absolute resistance value, the lower limit of working range is defined by a “knee” in an L-shaped resistance versus displacement data typical of the electrical measurements (see point K in FIG. 1).

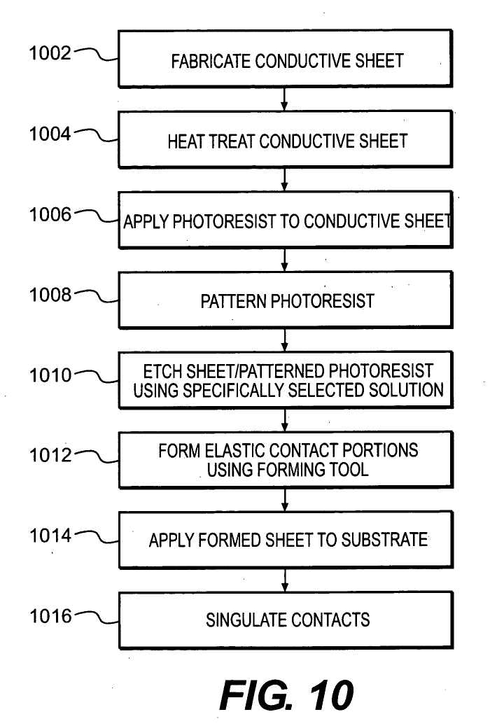

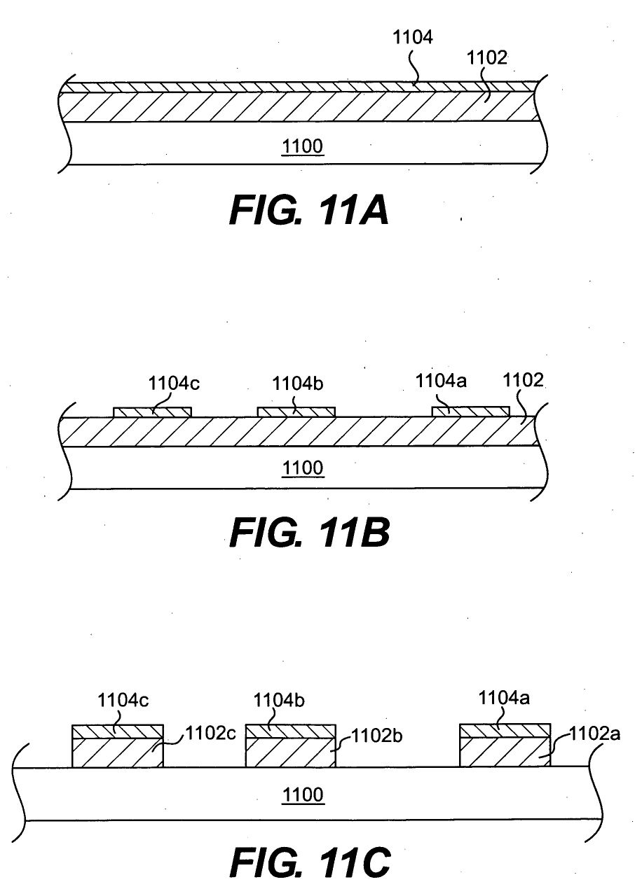

Finally, except for FIG. 9b, all the data illustrated in the following Figures was obtained from contacts having thickness of about 2 mils.

Large Working Range Single Sided Rolling Beam Contact

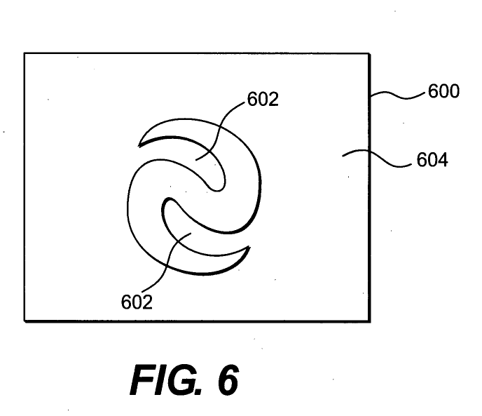

FIG. 4 is a plot of resistance and load versus displacement for a single sided rolling beam contact, formed according to an exemplary configuration of the present invention. The rolling beam contact measured for FIG. 4 had the structure of contact 200 disclosed in FIGS. 2 and 2b, and was formed as part of an array of connector elements whose pitch is 1.27 mm.

The data of FIG. 4 represents 100 cycles taken from one contact. In each measurement, the measuring apparatus was brought to within about 0 mils of a surface of beam portion 204, and a displacement of about 20 mils was achieved in the direction perpendicular to the plane of base portion 202. For each measurement, resistance dropped rapidly as electrical contact was established through the connector element. For displacement greater than about 5 mils, the resistance dropped below about 0.04 mΩ and remained below that value.

As shown in FIG. 4, the load increased from a zero value to about 41 grams at the maximum displacement of 20 mil. As evident from the load-displacement data, a similar curve was traced for all the measurements after the initial measurement designated by A. The reproducibility of load-displacement data throughout the 100 measurement cycles indicates that the rolling beam contact was exhibiting solely elastic behavior over a 20 mil displacement range.

In the example of FIG. 4, a working range comprising acceptable mechanical behavior, as well as acceptable resistance values for the rolling beam contact, can be defined. Using an Rmax value of 0.04 mΩ, a lower limit of a working range can be denoted by F, at about 6 mils of displacement, where all the measured R values lie substantially below Rmax. Because the load-displacement data indicate no onset of plastic flow up to the 20 mil displacement measured, if plastic flow onset is used as a defining criterion, an upper limit of working range corresponds the displacement limit of 20 mil. Alternatively, if a maximum allowable applied load of 50 g is used as a criterion, the maximum has not yet been reached at 20 mil displacement. In either case, assuming the experimental data plots contact behavior up to a displacement limit for the contact, an upper limit on working range corresponds to about 20 mil displacement. Thus, a working range of about 14 mils (the range between 6+ mil and 20 mil displacement) exists for the contact of FIG. 4 that is formed on an array of 1.27 mm (50 mils) pitch. The desired working range characteristics persisted during at least 100 measurement cycles, as indicated in FIG. 4.

The working range obtained for the contact measured for the data of FIG. 4 can be alternatively expressed as a normalized working range. Again, a normalized working range refers to a displacement value obtained for a given contact divided by a pitch of an array in which the contact is designed to reside. In this example, the normalized working range is about (14 mils)/(50 mils) or 0.28 for a single sided rolling beam.

High Durability Extended Rolling Beam Contact

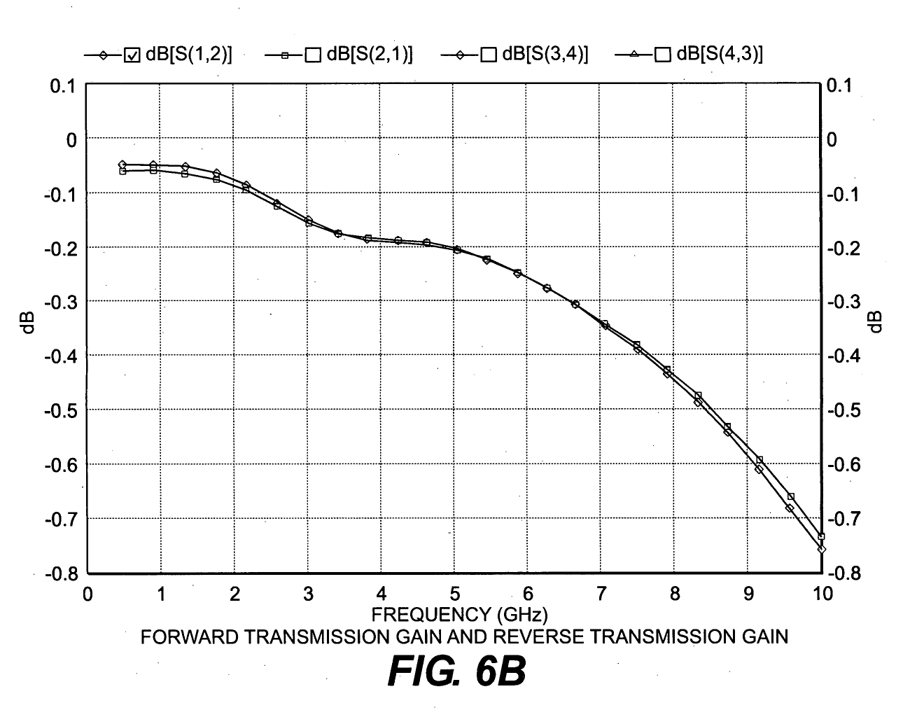

FIG. 5 is a load-displacement plot applied to an exemplary extended rolling beam contact of the present invention as illustrated in FIG. 2b. In this extended rolling beam contact, an elastic portion shaped as a rolling beam having a shape substantially similar to that of FIGS. 2 and 2b, had an actual dimension of 1.5 mm along a longest direction L, as indicated in FIG. 3. The rolling beam contact length is made greater than the pitch by interleaving two sets of beam elements. The exemplary contact measured for FIG. 5 was designed for an extremely high mechanical durability. The extended rolling beam contact was arranged in a connector array of 1.27 mm pitch.

The data shown in FIG. 5 were taken from approximately 40,000 measurement cycles comprising loading and unloading (increasing displacement and decreasing displacement). As is evident, all the data trace essentially the same curve within a very narrow range of variability. As in FIG. 4, an approximately ideal elastic behavior is displayed over the displacement range employed in the measurement.

The ability to withstand many tens of thousands of test cycles and maintain a reproducible elastic behavior renders the contact suitable for applications such as test sockets, where a connector may be connected and disconnected a similar amount of times. Again, conventional connectors designed on such a small pitch do not show such mechanical durability. Rather, for stamped spring connectors of similar dimension, a variation in load-displacement curves is observed after about 30-40 cycles, indicating a degradation in mechanical behavior of the spring.

Contact for Low Loss at High Frequency

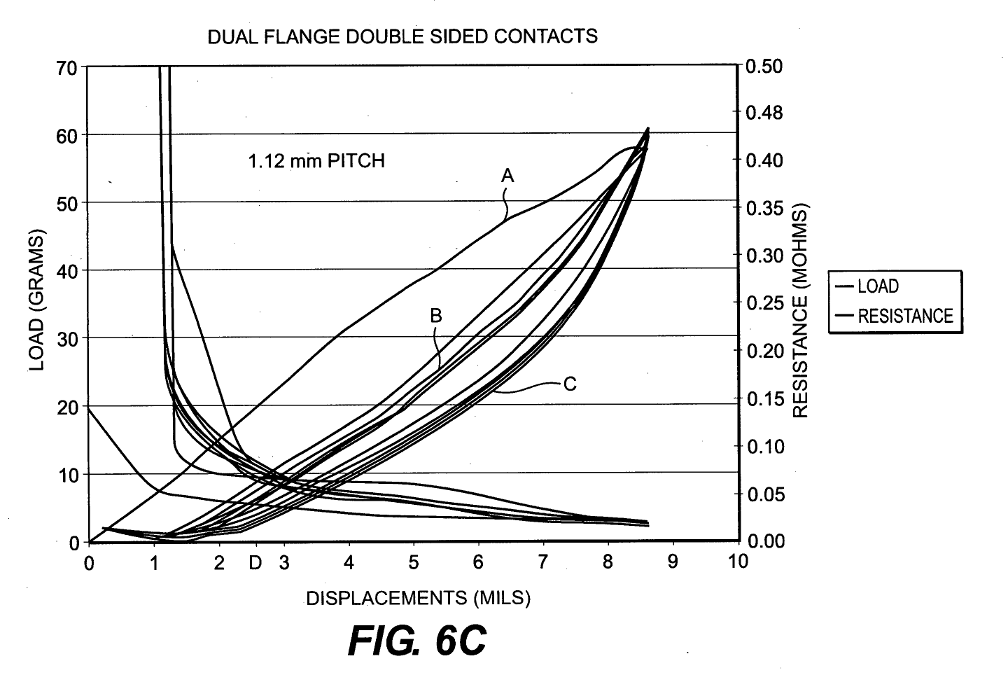

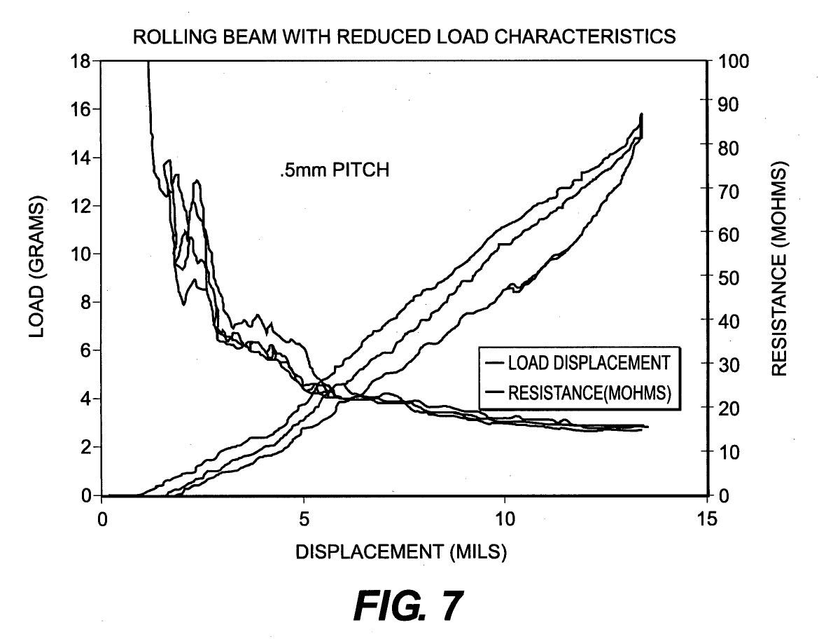

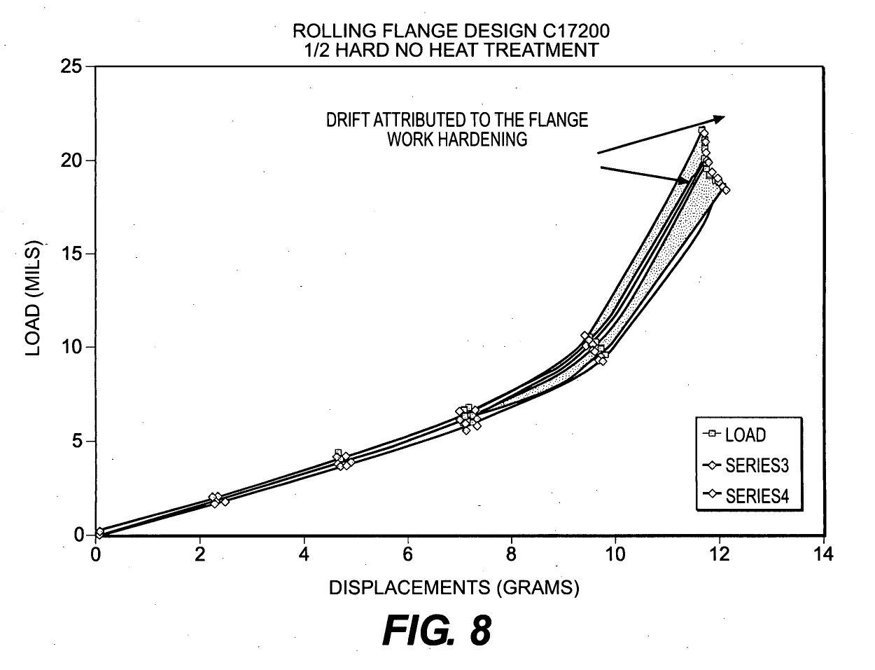

FIG. 6 provides a plan view illustration of an exemplary dual sided flanged contact structure according to a configuration of the present invention. FIG. 6b plots dB loss as a function of frequency for a 1.27 mm pitch contact having a structure similar to that of the contact of FIG. 6. FIG. 6c plots load and resistance versus displacement for a contact having a contact structure according of FIG. 6.

As shown in FIG. 6, contact 600 comprises two curved elastic portions 602 extending from a plane of a base 604. Contact 600 is formed in an array of 1.12 mm pitch. The elastic portions 602 are configured to have a short electrical path length defined as a length that current traveling through the elastic portion 602 travels when passing through a connector containing the contact. In the example shown, the electrical path length is about 1.14 mm.

Because of the short electrical path length, contact 600 provides a very low dB loss at high frequencies to meet high frequency application requirements. As illustrated in FIG. 6b, dB loss remained under a value of 0.8 at 10 GHz, indicating very low loss even for contacts operating at high frequencies.

In the data of FIG. 6c, resistance and load versus displacement measurements are taken up to a maximum value of about 9 mils displacement. After an initial insertion curve (A), subsequent load (B) and unload (C) curves are closely grouped together, with a hysteresis exhibited between load and unload cycles. Using an Rmax value of 0.08 mΩ, a lower limit of a working range can be denoted by D, at about 2.5 mm displacement, above which value all the measured R values lie below Rmax. A value of about 8 mils corresponds to an upper value of working range displacement, above which displacement an applied force exceeds 50 g.

Thus, a working range of about 5.5 mils exists for contact 600 of FIG. 6 formed on a 1.12 mm array pitch. The present invention can therefore provide a contact element with low dB loss up to 10 GHz and working range of 5.5 mils for a 1.12 pitch. Conventional contacts cannot achieve such a working range corresponding to the low resistance values and stable elastic behavior, while maintaining such a low dB loss at 10 GHz. In this example, the normalized working range is about 0.13.

Fine-Pitch Rolling Beam Contact

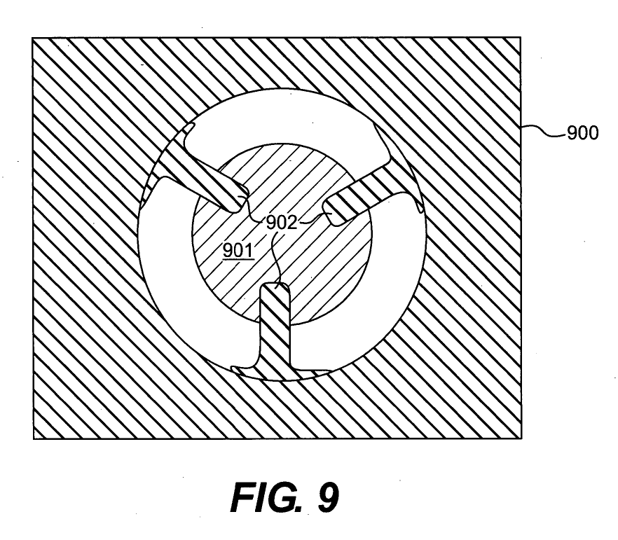

FIG. 7 plots load and resistance versus displacement for a contact having the same general shapes of base portion 202 and elastic portions 204 of contact structure 200 (FIG. 2), but having smaller dimensions and being arranged in an array of 0.5 mm pitch. Two cycles of loading and unloading are plotted. Even at 0.5 mm pitch (equivalent to about 19.7 mils), this configuration obtained a working range of about 8.7 mils, corresponding to applied displacements to a contact of between about 5 mils and about 13.7 mils, in which an acceptable resistance and reproducible elastic behavior were observed. Alternatively, a normalized working range for the contact of FIG. 7 can be calculated, equal to approximately (8.7 mil)/(19.7 mil), or about 0.44 for a single sided contact and 0.88 for a double sided contact.

Hardening of Single Sided Rolling Beam Contact

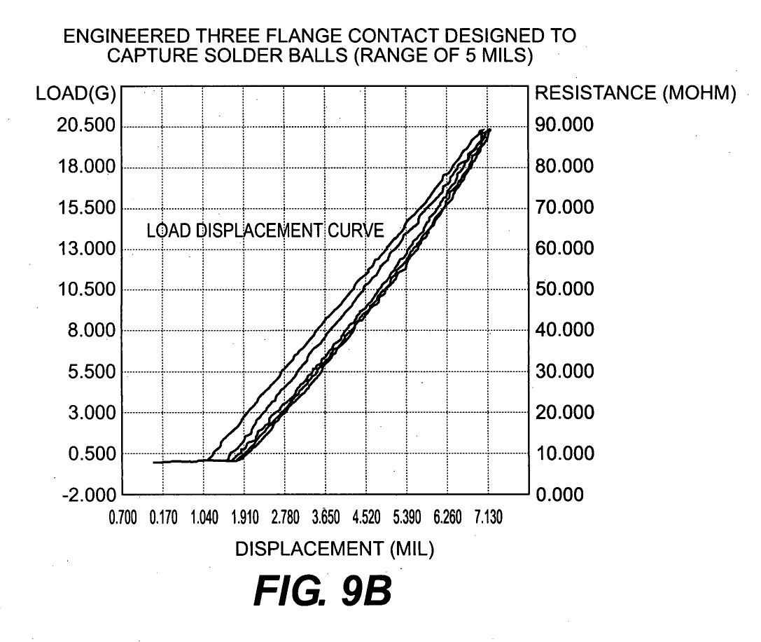

FIG. 8 illustrates load-displacement data for a single sided rolling beam contact arranged in a 1.27 mm pitch array and having the structure disclosed in FIGS. 2 and 2b. In this example, the contact comprised a “half-hard” metallic copper alloy that had not been subject to heat treatment before measurement. In FIG. 8, more than 18,000 loading and unloading cycles were performed. A smooth, gradual, and systematic shift in the load required for a given displacement was observed. This behavior is due to work hardening of metallic material within the rolling beam contact that is caused by loading and unloading, which in turn results in a stiffer elastic property for the beam element. Knowledge of the behavior exhibited in FIG. 8 allows a contact to be tailored according to the application for a connector to contain the contact. For example, if an application does not entail multiple mechanical loading and unloading of a connector containing the contact, a more compliant contact can be achieved by refraining from heat treatment of the contact.

Ultra-Thin Three Contact Flange for Solder Ball Contact

FIG. 9 illustrates a three flange (elastic contact portions) contact 900 designed to contact a solder ball 901, according to another configuration of the present invention. Flanges 902 are arranged at an approximately 120 degree separation along an arc of a circular opening. In the example shown, contact 900 is arranged in an array of contacts having a 1.27 mm pitch. Contact 900 comprises a thin metal having a thickness of about 1 mil. Thus, a thickness of base portion 904 and flanges 902 is about 1 mil.

FIG. 9b is a load-displacement plot illustrating three load-unload cycles of a contact having the structure and dimensions of contact 900. The slope of the load-displacement curve of FIG. 9b indicates a compliant spring “constant” for the three flange contact of FIG. 9. By reducing the thickness of a metallic layer (or “foil”) from which contacts having the structure of contact 900 are fabricated, a compliance of the elastic portions of the contacts can be increased, thus affording a greater displacement (and therefore working range) for a given contact size.

Discussion of Working Range

In the above examples, the working range feature was illustrated for the case where the working range variable parameter of interest was displacement, or external force. Values of working range for exemplary contacts were shown based on displacement ranges in which resistance of the electrical contact was within an acceptable range. It was shown that for contacts in arrays having pitches 0.5 to 1.27 mm, large s working ranges of about 6-14 mils or greater can be achieved. In the example of FIG. 6b, low dB loss at high frequency is illustrated for dual flange contacts. Thus, in configurations of the present invention, working range can encompass a contact displacement range through which several different properties are simultaneously satisfied (e.g., in FIGS. 6-6c: elastic response, low resistance, applied force within a tolerable range, and low loss at high frequency).

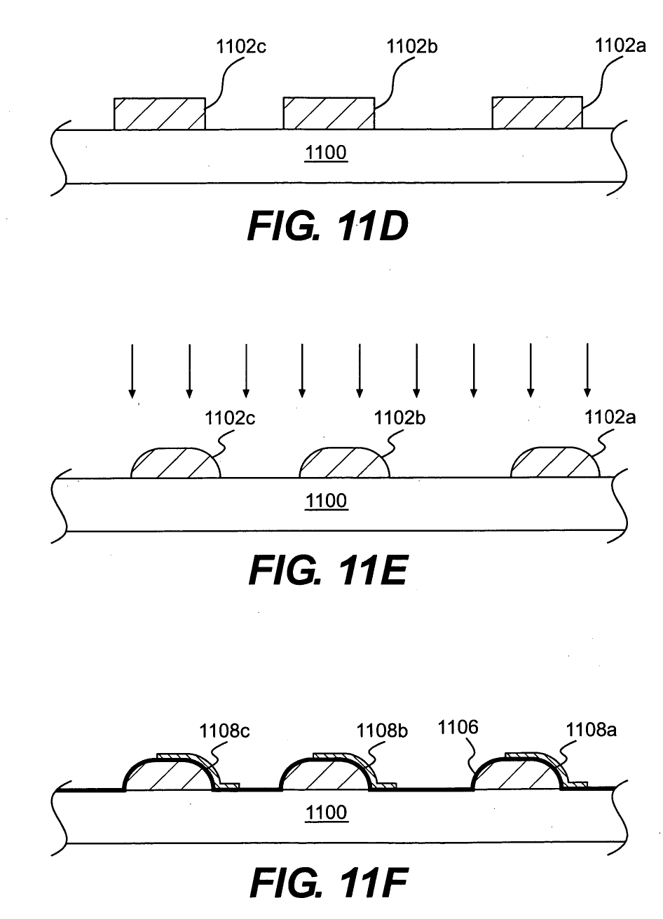

FIG. 10 illustrates exemplary steps of the invention in a process for forming an array of contacts. In step 1002, a conductive layer (or sheet) is fabricated. Depending on the sheet thickness, the conductive layer can be formed freestanding or on a substrate. In one example, a conductive metal is chosen that can provide a desired elasticity to an elastic contact portion. The conductive metal can include titanium (Ti) as a support structure that in additional substeps can be plated to obtain a desired electrical and/or elastic behavior. Alternatively, the conductive metal contains a copper alloy (Cu-alloy) or a multilayer metal sheet such as stainless steel coated with a copper-nickel-gold (Cu/Ni/Au) multilayer metal sheet. More specifically, the conductive metal can comprise a first layer containing small-grained copper beryllium (CuBe) that is plated with electroless nickel-gold (Ni/Au) to provide a non-oxidizing surface. Proper selection of material can enhance the working range of contacts formed from the conductive layer.

In optional step 1004, heat treatment of the conductive metal sheet is performed. For example, heat treatment of certain metallic materials transforms the materials from a half-hard state to a hard state.

In step 1006, a lithographically sensitive resist film is then applied to conductive metal sheet. A dry film can be used for larger feature sizes ranging from one to 20 mils, and a liquid resist can be used for feature sizes less than one mil.

In step 1008, the lithographically sensitive resist film is patterned according to a predetermined design for the contact. Specifically, ultraviolet (UV) light is used to expose the resist film through a mask containing the predetermined design, after which the resist is developed to define contact features in the photoresist. Portions that are intended to be etched are left unprotected by the mask. Using a lithographic process to define the contact features enables the printing of contacts having a fine resolution, similar to that found in semiconductor manufacturing. In one example, the mask contains an array of features that are spaced between each other according to a desired pitch. Preferably, the pitch is 1.5 mm or smaller.

In step 1010, the sheet is etched in a solution specifically selected for the conductive material being used. Each particular material that can be selected for the sheet typically has a specific etch chemistry that provides an optimum etch characteristics, such as etch rate (i.e., how well and how fast the solution performs the etch). Selection of an etchant also affects other characteristics like a sidewall profile of an etched contact feature, that is, the shape of an etch contour of a feature as seen in cross section. Exemplary etchants include cupric chloride, ferric chloride, and sulfuric hydroxide. Once etched, remaining portions of a layer of resist are removed in a stripping process, leaving etched features in the sheet. The etched features can include features elastic portions, such as beam portions 304 of FIG. 3b.

In step 1012, the patterned conductive metal sheet containing contact features is subject to a forming process, for example, using a batch forming tool. A batch forming tool can be designed according to the desired pitch of a contact array to be formed. In one example, the batch forming tool includes of a plurality of ball bearings arranged into an array format, preferably by being set into an array of openings in a support surface. The ball bearings can be of different sizes, to apply different forces to the contact features, thereby imparting different mechanical characteristics to contacts on the same sheet. The curvature of the ball bearings is used to push the contact features (or flanges) away from the plane of the conductive sheet. The flanges of the contacts are three dimensions by applying the forming tool to the sheet, to produce the desired elastic contact portions.

In step 1014, the formed contact sheet is applied to a substrate, preferably a planar insulating material, such that the elastic contact portions protrude from the surface of the planar substrate.

In step 1016, a singulation process is applied such that an array of individual (singulated) contacts is formed, so that the contacts are electrically isolated from one another.

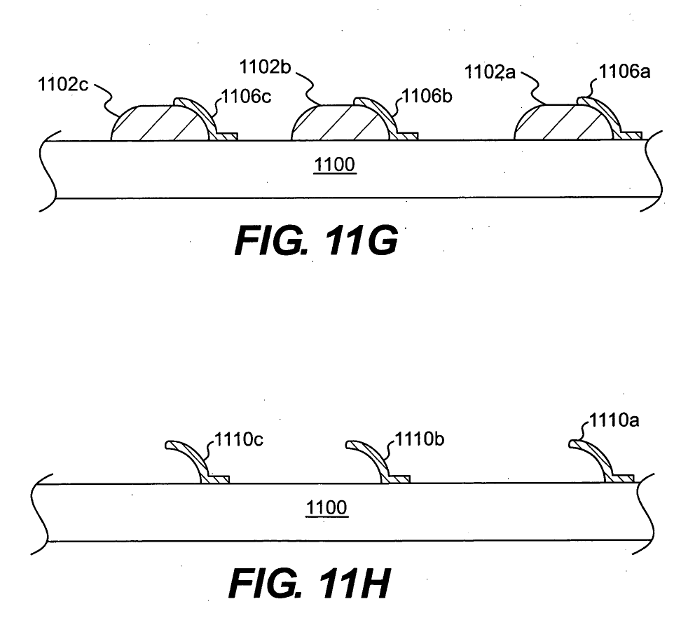

FIGS. 11a to 11h illustrate exemplary processing steps for forming a contact, for example, contact 200 of FIGS. 2-2b, according to another configuration of the present invention. Referring to FIG. 11a, a substrate 1100 on which the contact elements are to be located is provided. The substrate 1100 can be a silicon wafer or ceramic wafer, for example, and may include a dielectric layer formed thereon (not shown in FIG. 11a). The dielectric layer, of SOS, SOG, BPTEOS, or TEOS for example, can be formed on the substrate 1100 for isolating the contact elements from the substrate 1100. A support layer 1102 is formed on the substrate 1100. Support layer 1102 can be a deposited dielectric layer, such as an oxide or nitride layer, a spin-on dielectric, a polymer, or any other suitable etchable material. Support layer 1102 can be deposited by a number of different processes, including chemical vapor deposition (CVD), plasma vapor deposition (PVD), a spin-on process, or when the substrate 1100 is not covered by a dielectric layer or a conductive adhesive layer, support layer 1102 can be grown using an oxidation process commonly used in semiconductor manufacturing.

After support layer 1102 is deposited, a mask layer 1104 is formed on a top surface of support layer 1102. Mask layer 1104 is used in conjunction with a conventional lithography process to define a pattern on support layer 1102 using mask layer 1104. After the mask layer is printed and developed (FIG. 11b), a mask pattern, including regions 1104a to 1104c, is formed on the surface of support layer 1102 defining areas of support layer 1102 to be protected from subsequent etching.

Referring to FIG. 11c, an anisotropic etching process is performed using regions 1104a to 1104c as a mask. As a result of the anisotropic etching process, portions of the support layer 1102 not covered by a patterned mask layer are removed. Accordingly, support regions 1102a to 1102c are formed. The mask pattern including regions 1104a to 1104c is subsequently removed to expose the support regions (FIG. 11d).

Support regions 1102a to 1102c are then subjected to an isotropic etching process. An isotropic etching process removes material under etch in the vertical and horizontal directions at substantially the same etch rate. Thus, as a result of the isotropic etching, top corners of support regions 1102a to 1102c are rounded off as shown in FIG. 11e. The isotropic etching process can comprise a plasma etching process using SF₆, CHF₃, CF₄, or other well known chemistries commonly used for etching dielectric materials. Alternatively, the isotropic etching process is a wet etch process, such as a wet etch process using a buffered oxide etch (BOE).

Referring to FIG. 11f, a metal layer 1106 is formed on the surface of the substrate 1100 and the surface of support regions 1102a to 1102c. Metal layer 1106 can be a copper layer, a copper alloy (Cu-alloy) layer, or a multilayer metal deposition such as tungsten coated with copper-nickel-gold (Cu/Ni/Au). Preferably, the contact elements are formed using a small-grained copper beryllium (CuBe) alloy, and are then plated with electroless nickel-gold (Ni/Au) to provide a non-oxidizing surface. Metal layer 1106 can be deposited by a CVD process, electro plating, sputtering, PVD, or other conventional metal film deposition techniques. A mask layer is deposited and patterned into mask regions 1108a to 1108c using a conventional lithography process. Mask regions 1108a to 1108c define areas of the metal layer 1106 to be protected from subsequent etching.

The structure in FIG. 11f is then subjected to an etching process for removing the portions of the metal layer not covered by mask regions 1108a to 1108c. As a result, metal portions 1106a to 1106c are formed as shown in FIG. 11g. Each of metal portions 1106a to 1106c includes a base portion formed on substrate 1100 and a curved elastic portion formed on a respective support region (1102a to 1102c). Accordingly, when viewed in cross-section, the curved elastic portion of each metal portion assumes a shape substantially the same as that of the underlying support region, projecting above the surface of substrate 1100.

In step 11h, support regions 1102a to 1102c are removed, such as by using a wet etch, an anisotropic plasma etch, or other etch process. If the support layer is formed using an oxide layer, a buffered oxide etchant can be used to remove the support regions. As a result, free standing elastic contact portions 1110a to 1110c are formed on substrate 1100.

The foregoing disclosure of configurations of the present invention has been presented for purposes of illustration and description. It is not intended to be exhaustive or to limit the invention to the precise forms disclosed. Many variations and modifications of the configurations described herein will be apparent to one of ordinary skill in the art in light of the above disclosure. The scope of the invention is to be defined only by the claims appended hereto, and by their equivalents.

For instance, data in FIGS. 4-9 was taken from contacts whose array spacings ranged from about 0.5-1.27 mm. However, other configurations contemplated include arrays of contacts where array pitch is as small as about 0.05 mm. Because lithographic processes used in configurations of the present invention are operable for planar dimensions at least as small as 65-90 nm, configurations of the present invention having contact elements of similar lateral (in-plane) dimension are contemplated. Additionally, film thickness of metallic films used to form base and elastic contact portions can be reduced to at least about 10 nm while still imparting low resistance to contacts formed therefrom. Finally, regular arrays of three dimensional bodies can be fabricated as small as 10 microns to form a template from which three dimensional elastic contact portions of similar overall dimensions can be fabricated. In light of the foregoing, large working range and large normalized working range can be realized for electrical contacts fabricated on sub-millimeter, micron- and sub-micron array pitches.

In another configuration of the present invention, an elastic contact having enhanced working range includes an elastic contact portion having a shape that is tapered along a long direction of the contact portion within a plane of the contact. A region of the elastic portion near a base portion has a first width, while a distal region has a second width, the second width being substantially narrower than the first width. By incorporating a narrower distal end in an elastic contact portion, a compliance of the contact can be increased.

In another configuration of the present invention, an elastic contact includes an elastic contact portion having a thickness that is tapered along a long direction of the contact portion. A region of the elastic portion near a base portion has a first thickness, while a distal region has a second thickness, the second thickness being substantially narrower than the first thickness, resulting in an increased compliance for the contact.

In another configuration of the present invention, an elastic contact contains an elastic contact portion having a fillet beam shape. The fillet beam shape comprises a fillet region of an elastic beam, the region located near a base region.

Additionally, although in exemplary contacts discussed above, a base portion surrounds an elastic portion, the present invention is capable of operation in other configurations in which the elastic and base portions are arranged in any fashion that provides for electrical continuity between a planar base portion and a protruding elastic portion.

Further, in describing representative configurations of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. An electrical contact in a contact array, the array having a pitch less than about 1.5 mm, the contact engineered to meet specific design requirements including a working range, the contact fabricated by lithographic patterning and etching of a conductive layer, plating of conductive material on the patterned conductive layer, and conducting a forming process on the patterned conductive layer to form an elastic contact portion.

2. A contact in an electrical connector, comprising;
a base portion disposed substantially within a plane containing an array of contacts, the array having a pitch within a range of about 0.05 mm to about 5.0 mm; and
an elastic portion integral with the base portion, protruding above the plane of the base portion, and configured to produce a working range of about 0.0 to about 1.0 mm.

3. The contact of claim 2, an upper limit of the working range corresponding to an applied force of 50 g.

4. The contact of claim 2, a lower limit of the working range characteristics are represented as being determined by a knee in a resistance versus displacement curve.

5. The contact of claim 2, a lower limit of the working range corresponding to a displacement above which a measured resistance of the contact is less than 15 mΩ.

6. The contact of claim 2, the working range comprising a range in which a contact dB loss is less than about 1 at frequencies up to about 10 GHz.

7. The contact of claim 2, the contact having a contact electrical path length less than about 0.7 times the array pitch.

8. The contact of claim 2, the contact fabricated by:
providing a substrate for forming the contact thereon,
forming a conductive layer on the substrate, the conductive layer providing a first surface,
etching the conductive layer to define the base portion and the elastic portion, and
deforming at least a portion of the elastic portion, the elastic portion being configured to protrude from the first surface to provide a deformable, conductive path between the base portion and the elastic portion.

9. A rolling beam contact of a connector array, comprising:
a base portion disposed substantially within a plane containing an array of contacts, the array having a pitch within a range of about 0.05 mm to about 1.27 mm; and
an elastic portion comprising one or more rolling beams that are integral with the base portion and protrude above the plane of the base portion in an upward curving shape, the rolling beam contact providing a working range of about 0.0 mm to about 1.0 mm.

10. The rolling beam contact of claim 9, the rolling beam contact configured to withstand more than 100 load-unload cycles over a displacement range of 20 without change in elastic behavior.

11. The rolling beam contact of claim 9, the rolling beam contact fabricated by:
providing a substrate for forming the rolling beam contact thereon,
forming a conductive layer on the substrate, the conductive layer providing a first surface,
etching the conductive layer to define the base portion and the elastic portion, and
deforming at least a portion of the elastic portion, the elastic portion being configured to protrude from the first surface to provide a deformable, conductive path between the base portion and the elastic portion.

12. A multi-flange solder ball contact of a connector array, comprising:
a base portion disposed substantially within a plane containing an array of contacts, the array having a pitch within a range of about 0.05 mm to about 1.27 mm; and
an elastic portion comprising a plurality of flanges integral with the base portion, protruding from a substantially circular inner perimeter of the base portion above the plane of the base portion, and configured to engage a solder ball, the contact providing a displacement of about 0.00 mm to about 1.0 mm.

13. The multi-flange solder ball contact of claim 12, the plurality of flanges comprising three flanges.

14. The multi-flange solder ball contact of claim 13, the pitch being about 1.27 mm and the contact being elastically deformable through a displacement of about 5 mils.

15. The multi-flange solder ball contact of claim 12, the multi-flange solder ball contact fabricated by:
providing a substrate for forming the multi-flange solder ball contact thereon,
forming a conductive layer on the substrate, the conductive layer providing a first surface,
etching the conductive layer to define the base portion and the elastic portion, and
deforming at least a portion of the elastic portion, the elastic portion being configured to protrude from the first surface to provide a deformable, conductive path between the base portion and the elastic portion.

16. A contact in an electrical connector, comprising;
a base portion disposed substantially within a plane containing an array of contacts, the array having a pitch within a range of about 0.05 mm to about 1.27 mm; and
an elastic portion integral with the base portion, protruding above the plane of the base portion, and configured to produce a normalized working range of about 0.1 to about 0.44.

17. The contact of claim 16, an upper limit of a displacement used to define the normalized working range corresponding to an applied force of 50 g.

18. The contact of claim 16, a lower limit of a displacement used to define the normalized working range being determined by a knee in a resistance versus displacement curve.

19. The contact of claim 16, a lower limit of a displacement used to define the normalized working range corresponding to a displacement above which a measured resistance of the contact is less than about 15 mΩ.

20. A double sided contact in an electrical connector having contacts on opposed sides of a substrate, each contact comprising:
a base portion disposed substantially within a plane containing an array of contacts, the array having a pitch within a range of about 0.05 mm to about 1.27 mm; and
an elastic portion integral with the base portion, protruding above the plane of the base portion, the double sided contact configured to produce a normalized working range of about 0.2 to about 0.88.

21. A method for fabricating electrical contacts in a contact array, comprising: designing a size and shape of a contact including an elastic portion according to specific design requirements, the design requirements including an array pitch of less than about 1.5 mm and a desired working range;
defining the contact using a lithographic pattern according to the designed shape and size of the contact;
etching a conductive layer using the lithographic pattern to produce a contact structure;
forming the contact structure to produce an elastic portion having a predetermined displacement designed to achieve the desired working range;
plating the contact structure to impart properties that meet the specific design requirements; and
singulating the contact structure to form a contact deposed on a substrate and electrically isolated from other contacts in the contact array.
